(19) United States
(12) Patent Application Publication
(10) Pub. No.: US 2024/0258749 A1
(43) Pub. Date: Aug. 1, 2024

(54) CONNECTOR DEVICE

(71) Applicant: I-PEX Inc., Kyoto-shi (JP)

(72) Inventor: Sho SUZUKI, Machida-city (JP)

(21) Appl. No.: 18/630,267

(22) Filed: Apr. 9, 2024

Related U.S. Application Data
(63) Continuation of application No. PCT/JP2022/030655, filed on Aug. 10, 2022.

(30) Foreign Application Priority Data
Oct. 14, 2021 (JP) 2021-168552

(51) Int. Cl. H01R 13/6594; H01R 12/71

(52) U.S. Cl. CPC H01R 13/6594; H01R 12/716

(57) ABSTRACT

A connector device includes a first connector and a second connector. The first connector includes a first contact, an insulating first housing, and a first shell having a first side portion surrounding an outer periphery of the first housing and a bottom portion extending along the first board within a region surrounded by the first side portion. The second connector includes a second contact, an insulating second housing, and a second shell having a second side portion surrounding an outer periphery of the second housing and an upper portion extending within a region surrounded by the second side portion. In a state where the first connector and the second connector are fitted to each other, the first contact comes into contact with the second contact, the first side portion comes into contact with the second side portion, and the bottom portion comes into contact with the upper portion.

### CROSS-REFERENCE TO RELATED APPLICATIONS

This application is a continuation application of PCT Application No. PCT/JP2022/030655, filed on Aug. 10, 2022, which claims the benefit of priority from Japanese Patent Application No. 2021-168552, filed on Oct. 14, 2021. The entire contents of the above listed PCT and priority applications are incorporated herein by reference.

### BACKGROUND

The present disclosure relates to a connector device.

Japanese Unexamined Patent Publication No. 2017-208165 discloses a connector assembly in which a side plate portion is provided in a plug shield member of a plug connector in fitting connection between the plug connector and a receptacle connector. In this connector assembly, double shielding is performed by a side plate portion having a bent section having two leg portions.

In the connector assembly (connector device) illustrated in Japanese Unexamined Patent Publication No. 2017-208165, it is desired to further improve shielding performance. Therefore, the present disclosure provides a connector device which may be configured to improve shielding performance.

### SUMMARY

A connector device according to an aspect of the present disclosure includes a first connector and a second connector fitted to the first connector. The first connector includes a first contact having a first type contact and a second type contact configured to transmit a high frequency signal of a higher frequency than a signal transmitted by the first type contact, the first contact being electrically connected to a conductor of a first board, an insulating first housing configured to hold the first contact, and a first shell having a first side portion and a bottom portion. The first side portion surrounds an outer periphery of the first housing. The bottom portion is continuous with an end portion of the first side portion in a direction close to the first board. The bottom portion extends along the first board within a region surrounded by the first side portion. The first shell is electrically connected to a ground conductor of the first board. The second connector includes a second contact electrically connected to a conductor of a second board, an insulating second housing configured to hold the second contact, and a second shell having a second side portion and an upper portion. The second side portion surrounds an outer periphery of the second housing. The upper portion is continuous with an end portion of the second side portion in a direction away from the second board. The upper portion extends within a region surrounded by the second side portion. The second shell is electrically connected to a ground conductor of the second board. In a state where the first connector and the second connector are fitted to each other, the first contact comes into contact with the second contact, the first side portion comes into contact with the second side portion, and the bottom portion comes into contact with the upper portion.

In the connector device according to the aspect of the present disclosure, in a state where the first connector and the second connector are fitted to each other, the first side portion of the first shell and the second side portion of the second shell come into contact with each other, and the bottom portion continuous with the first side portion and the upper portion continuous with the second side portion come into contact with each other. The first shell and the second shell come into contact with each other at two points of the portion integrally formed in this manner, and thus, a ground potential difference between the first shell and the second shell is reduced. As a result, since the shielding performance in the fitted state is stabilized, the shielding performance of the connector device may be improved.

In some examples of the present disclosure, the connector device may be configured to improve shielding performance.

### BRIEF DESCRIPTION OF THE DRAWINGS

FIG. 1 is a diagram illustrating a state before fitting of each connector in an example of a connector device.

FIGS. 2A to 2C are diagrams illustrating an example of a plug connector. FIG. 2A is a plan view, FIG. 2B is a bottom view, and FIG. 2C is a perspective view.

FIGS. 3A to 3C are diagrams illustrating an example of a plug contact and a plug shell. FIG. 3A is a plan view, FIG. 3B is a bottom view, and FIG. 3C is a perspective view.

FIGS. 4A to 4C are diagrams illustrating an example of a receptacle connector. FIG. 4A is a plan view, FIG. 4B is a bottom view, and FIG. 4C is a perspective view.

FIGS. 5A to 5C are diagrams illustrating an example of a receptacle contact and a receptacle shell. FIG. 5A is a plan view, FIG. 5B is a bottom view, and FIG. 5C is a perspective view.

FIGS. 6A to 6C are diagrams illustrating an example of the connector device in a fitted state. FIG. 6A is a plan view, FIG. 6B is a bottom view, and FIG. 6C is a perspective view.

FIGS. 7A to 7C are diagrams illustrating an example of the connector device in the fitted state. FIG. 7A is a bottom view, FIG. 7B is a sectional view illustrating a section taken along line A-A in FIG. 7A, and FIG. 7C is a sectional view illustrating a section taken along line B-B in FIG. 7A.

### DETAILED DESCRIPTION

Hereinafter, an example will be described in detail with reference to the drawings. In the description, the same elements or elements having the same function are denoted by the same reference numerals, and redundant description will be omitted.

### [Connector Device]

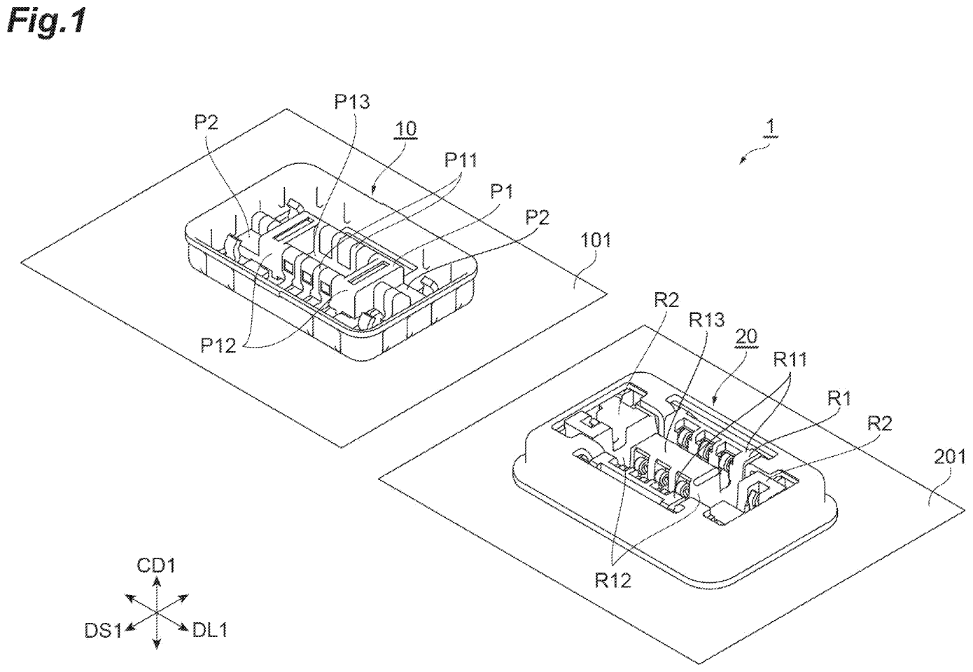

A connector device 1 illustrated in FIG. 1 is a device used for connecting circuit boards in an electronic device. Specific examples of the electronic device include, but are not limited to, a portable communication terminal such as a mobile phone, a smartphone, a laptop computer, or a tablet computer.

As illustrated in FIG. 1, the connector device 1 includes a plug connector 10 and a receptacle connector 20 which are attached to boards 101 and 201 that are two circuit boards, respectively. A plurality of conductors (conductors constituting a part of a signal circuit) and a ground conductor (conductor constituting a part of a ground circuit) (not illustrated) are formed on the board 101 and the board 201, respectively. The connector device 1 electrically connects the conductors on two boards 101 and 201 by fitting the plug connector 10 and the receptacle connector 20. Note that, in FIG. 1, the plug connector 10 is illustrated in a vertically inverted state in a vertical direction which is a fitting direction.

In a state where the plug connector 10 and the receptacle connector 20 are fitted to each other, both a shape of the plug connector 10 viewed from the receptacle connector 20 and a shape of the receptacle connector 20 viewed from the plug connector 10 approximate to a rectangle. Hereinafter, a direction along a long side of the rectangle is referred to as a long side direction DL1, and a direction along a short side of the rectangle is referred to as a short side direction DS1. In addition, a direction perpendicular to the long side direction DL1 and the short side direction DS1 is referred to as a connection direction CD1 (or fitting direction) of the plug connector 10 and the receptacle connector 20. Hereinafter, when a structure of the plug connector 10 viewed from the receptacle connector 20 is described in a state where the plug connector 10 and the receptacle connector 20 are fitted to each other, it is simply referred to as “viewed from the receptacle connector 20”, and when a structure of the receptacle connector 20 viewed from the plug connector 10 is described, it is simply referred to as “viewed from the plug connector 10”. “Viewed from the receptacle connector 20” corresponds to plan view of the plug connector 10. “Viewed from the plug connector 10” corresponds to plan view of the receptacle connector 20.

### [Plug Connector]

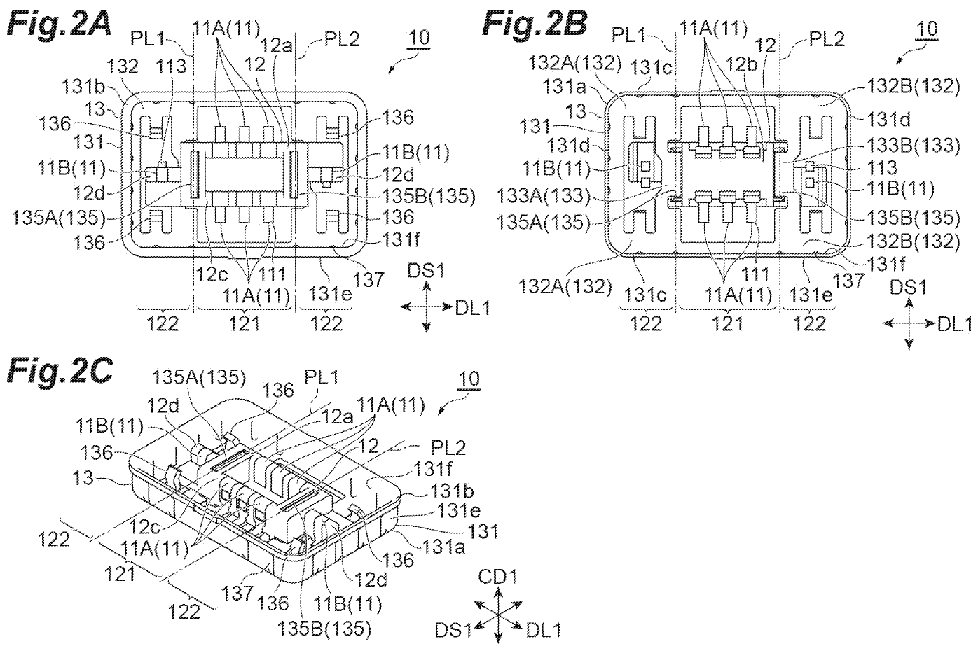

First, a configuration of the plug connector 10 will be described in detail. The plug connector 10 is attached to the board 101 and is connected to the receptacle connector 20 which is a mating connector. As illustrated in FIGS. 2A to 2C, the plug connector 10 includes a plug contact 11, a plug housing 12, and a plug shell 13.

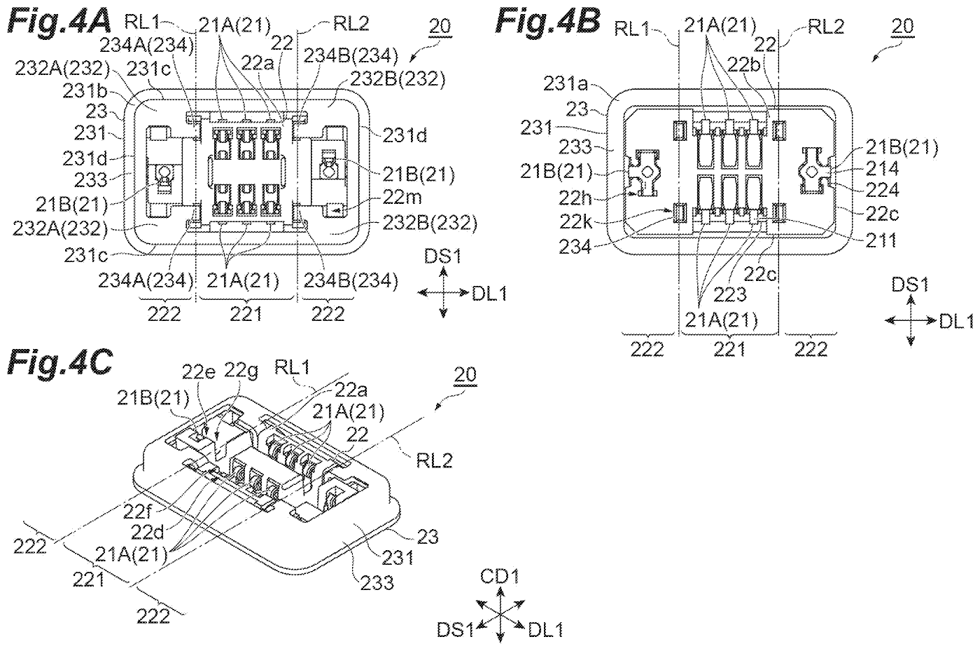

The plug contact 11 is a conductive member electrically connected to a conductor (for example, signal conductor) of the board 101. In a state where the plug connector 10 and the receptacle connector 20 are fitted to each other (hereinafter, may be simply referred to as a “fitted state”), the plug contact 11 comes into contact with the receptacle contact 21 of the receptacle connector 20 (see FIGS. 4A to 4C).

The plug contact 11 have contacts of different types. A case where the types are different from each other means that contacts belong to different types under some definition for specifying a difference in type. Specific examples of the case where the types are different from each other include a difference in a frequency bandwidth of a signal to be transmitted, a difference in allowable current, a difference in allowable voltage, and a difference in whether the contact is for connection of the signal conductor (conductor constituting a part of the signal circuit) or for connection of the ground conductor (conductor constituting a part of the ground circuit). For example, the plug contact 11 includes one or a plurality of first type contacts 11A and one or a plurality of second type contacts 11B of a type different from the first type contact 11A. The second type contact 11B is a contact for transmitting a high frequency signal having a higher frequency than the signal transmitted by the first type contact 11A.

As an example, the plug contact 11 includes six first type contacts 11A and two second type contacts 11B as illustrated in FIGS. 2A to 2C. In the long side direction DL1, for example, two second type contacts 11B are disposed at both ends, and six first type contacts 11A are disposed to be sandwiched between the two second type contacts 11B. In six first type contacts 11A, three sets of a pair of first type contacts 11A facing each other in the short side direction DS1 are disposed in the long side direction DL1. As viewed from the receptacle connector 20, six first type contacts 11A and two second type contacts 11B are disposed along the connection direction CD1.

The first type contacts 11A protrude toward the receptacle connector 20 along the connection direction CD1 to be sandwiched between first type contacts 21A (see FIGS. 4A to 4C) of the receptacle connector 20 in the fitted state. The first type contact 11A is formed by punching one plate material from a metal plate and performing bending or the like on the plate material. The first type contact 11A is provided within the plug connector 10 along the short side direction DS1 to be connected to the conductor of the board 101.

The second type contacts 11B protrude toward the receptacle connector 20 along the connection direction CD1 to come into contact with the second type contacts 21B (see FIGS. 4A to 4C) of the receptacle connector 20 in the fitted state. The second type contact 11B is formed by punching one plate material from a metal plate and performing bending or the like on the plate material. The second type contact 11B is provided near both ends within the plug connector 10 along the long side direction DL1 to be connected to the conductor of the board 101.

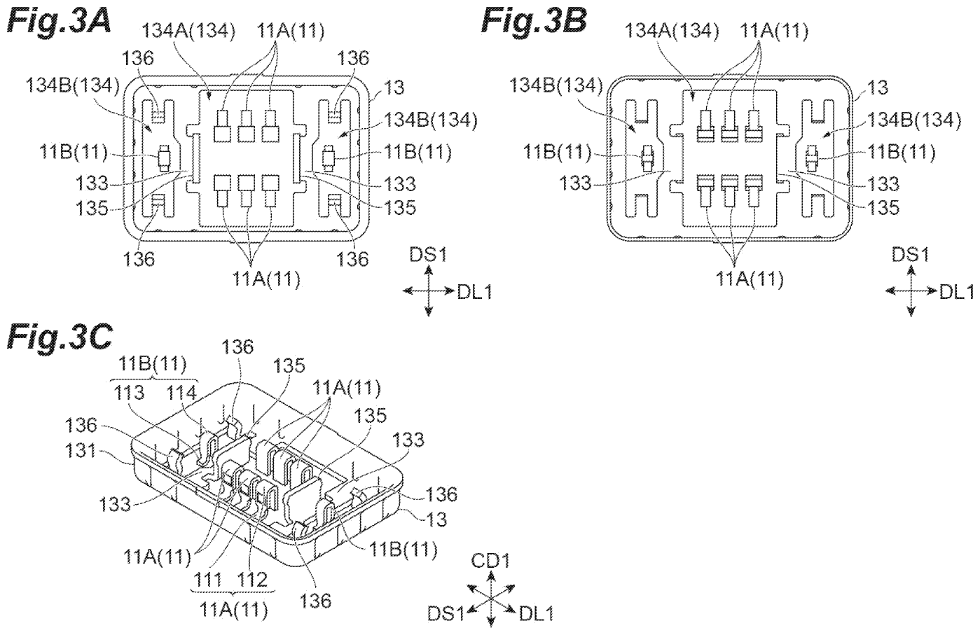

As illustrated in FIGS. 3A to 3C, the first type contact 11A includes a connection portion 111 and a contact portion 112. The connection portion 111 is connected to the conductor (for example, signal conductor) of the board 101 by soldering or the like. The connection portion 111 extends outward along the short side direction DS1. The contact portion 112 comes into contact with the first type contact 21A (see FIGS. 4A to 4C) of the receptacle connector 20. The contact portion 112 protrudes from a base end of an extension portion of the connection portion 111 toward the receptacle connector 20 along the connection direction CD1. The connection portion 111 and the contact portion 112 are coupled to each other. The first type contact 11A may have any shape as long as the first type contact can be attached to the board 101, and for example, may have a shape in which the connection portion 111 does not extend outward.

The second type contact 11B has a connection portion 113 and a contact portion 114. The connection portion 113 is connected to the conductor (for example, signal conductor) of the board 101 by soldering or the like. The connection portion 113 extends outward along the short side direction DS1. The contact portion 114 is a contact portion of the receptacle connector 20 with the second type contact 21B (see FIGS. 4A to 4C). The contact portion 114 protrudes from a base end of an extension portion of the connection portion 113 toward the receptacle connector 20 along the connection direction CD1. The connection portion 113 and the contact portion 114 are coupled to each other.

The plug housing 12 illustrated in FIGS. 2A to 2C is an insulating member that holds the plug contact 11. The plug housing 12 is formed integrally with the plug contact 11 by insert molding of a resin material, for example, in a state where the plug contact 11 is disposed. As illustrated in FIG. 1, the plug housing 12 has a first portion P1 that approximates a rectangle as viewed from the receptacle connector 20, and second portions P2 provided at both ends of the first portion P1 in the long side direction DL1. The first portion P1 includes a pair of first wall portions P11 and P11 extending along the long side direction DL1 and a pair of second wall portions P12 and P12 extending along the short side direction DS1. In the first portion P1, a recess portion P13 surrounded by the pair of first wall portions P11 and P11 and the pair of second wall portions P12 and P12 is formed. The recess portion P13 is a space for housing a protrusion portion R13 of the receptacle connector 20 in the fitted state. As illustrated in FIGS. 2A to 2C, the plug housing 12 has a front surface 12a facing the receptacle connector 20 and a back surface 12b facing the board 101 in the connection direction CD1.

The plug housing 12 is partitioned into a plurality of holding areas in a direction perpendicular to the connection direction CD1. The plurality of holding areas include, for example, one first type holding area 121 and two second type holding areas 122. For example, the first wall portion P11 of the first portion P1 corresponds to the first type holding area 121 (specifically, a raised portion 12c of the first type holding area 121). In addition, the second portion P2 corresponds to the second type holding area 122 (specifically, a raised portion 12d of the second type holding area 122). The first type holding area 121 and the second type holding area 122 are partitioned by, for example, boundaries PL1 and PL2 perpendicular to the long side direction DL1. In the plug housing 12, for example, both ends in the long side direction DL1 are partitioned as two second type holding areas 122, and a region sandwiched between the two second type holding areas 122 is partitioned as the first type holding area 121. That is, the plug housing 12 is partitioned into the second type holding area 122, the first type holding area 121, and the second type holding area 122 in this order along the long side direction DL1. Hereinafter, two second type holding areas 122 may be collectively referred to as the second type holding area 122.

The first type holding area 121 holds one or a plurality (for example, six) of first type contacts 11A. In the following description, a case where the first type holding area 121 holds six first type contacts 11A will be described. The second type holding area 122 holds one or a plurality of second type contacts 11B. In the following description, a case where each second type holding area 122 holds one second type contact 11B will be described.

The first type holding area 121 has the raised portion 12c protruding toward the receptacle connector 20 along the connection direction CD1. The raised portion 12c holds the first type contact 11A. A side surface of the raised portion 12c is formed from the front surface 12a to the back surface 12b. The first type contact 11A is attached to be exposed on the side surface of the raised portion 12c. The raised portion 12c is housed in a housing groove portion 22f (see FIG. 4C) of the receptacle connector 20.

The second type holding area 122 has the raised portion 12d protruding toward the receptacle connector 20 along the connection direction CD1. The raised portion 12d holds the second type contact 11B. A side surface of the raised portion 12d is formed from the front surface 12a to the back surface 12b. The second type contact 11B is attached to be exposed on the side surface of the raised portion 12d. The raised portion 12d is housed in a housing groove portion 22g (see FIG. 4C) of the receptacle connector 20.

The first type contact 11A held by the first type holding area 121 is adjacent to the second type contact 11B held by one second type holding areas 122 via the boundary PL1. In addition, the first type contact 11A held in the first type holding area 121 is adjacent to the second type contact 11B held by the other second type holding area 122 via the boundary PL2. An interval in the long side direction DL1 between the first type contact 11A and the second type contact 11B adjacent to each other via the boundaries PL1 and PL2 is larger than an interval between the first type contacts 11A adjacent to each other along the long side direction DL1 within the first type holding area 121.

As viewed from the receptacle connector 20, the connection portion 111 of the first type contact 11A held by the first type holding area 121 is exposed from the plug housing 12 along the short side direction DS1. In addition, as viewed from the receptacle connector 20, the connection portion 113 of the second type contact 11B held by the second type holding area 122 is exposed from the plug housing 12 along the short side direction DS1. Accordingly, a connection state (implementation state) of the first type contact 11A and the second type contact 11B with respect to the board 101 may be confirmed visually.

The plug shell 13 illustrated in FIGS. 2A to 2C is a conductive member electrically connected to the ground conductor of the board 101 by soldering or the like. The plug shell 13 surrounds a region having an outer shape that approximates a rectangle as viewed from the receptacle connector 20. The plug shell 13 is disposed to surround an outer periphery of the plug housing 12. The plug shell 13 has a side portion 131 and a bottom portion 132. In the plug shell 13, the side portion 131 which is a side surface portion and the bottom portion 132 which is a bottom surface portion are integrally provided, in a member having a square container-shape formed by drawing a metal plate (for example, square tube drawing). Since the plug shell 13 is formed by drawing, a joint is not formed on the side portion 131.

The side portion 131 surrounds the outer periphery of the plug housing 12 to have a substantially quadrangular shape as viewed from the receptacle connector 20. The plug contact 11 is disposed in a region surrounded by the side portion 131. The side portion 131 has a pair of side wall portions 131c and 131c along a longitudinal direction (long side direction DL1) on the outer periphery of the plug housing 12, and a pair of end wall portions 131d and 131d continuous with the side wall portions 131c and along a direction (short side direction DS1) orthogonal to the longitudinal direction on the outer periphery of the plug housing 12 (see FIG. 2B).

The side portion 131 may have a protrusion portion 137 protruding inward from an inner peripheral surface 131f. The protrusion portion 137 is formed, for example, by performing dimple processing or the like from an outer peripheral surface 131e of the side portion 131 toward the inner peripheral surface 131f. The protrusion portion 137 may include a plurality of protrusion portions 137. For example, the protrusion portion 137 may be formed on each of the side wall portion 131c and the end wall portion 131d. The protrusion portion 137 presses the side portion 231 (see FIGS. 4A to 4C) of the receptacle connector 20 in a state where the plug connector 10 and the receptacle connector 20 are fitted to each other.

The bottom portion 132 continues with an end portion 131a of the side portion 131 in a direction close to the board 101 and extends along the board 101 within the region surrounded by the side portion 131. The bottom portion 132 is provided to be continuous with both of two sides (that is, the side wall portion 131c and the end wall portion 131d) that constitute the side portion 131 and intersect with each other at four corners of the side portion 131 as viewed from the receptacle connector 20. As viewed from the receptacle connector 20, the bottom portion 132 covers a part of the board 101.

The bottom portion 132 is electrically connected to the ground conductor (not illustrated) of the board 101. The bottom portion 132 may be directly connected to the ground conductor of the board 101, or may be connected to the ground conductor of the board 101 via another portion of the plug shell 13. In the following description, a case where the bottom portion 132 is directly connected to the ground conductor of the board 101 will be described.

The bottom portion 132 includes a bottom portion 132A and a bottom portion 132B, a coupling portion 133, and engaging portions 136. As illustrated in FIG. 2B, the bottom portion 132A and the bottom portion 132B are provided to correspond to two second type holding areas 122. The bottom portion 132A has a portion (first corner portion) continuous with both the end portion 131a of one side wall portion 131c in the direction close to the board 101 and the end portion 131a of one end wall portion 131d and a portion (second corner portion) continuous with both the end portion 131a of the other side wall portion 131c and the end portion 131a of one end wall portion 131d. In addition, the bottom portion 132B has a portion (third corner portion) continuous with both the end portion 131a of one side wall portion 131c and the end portion 131a of the other end wall portion 131d and a portion (fourth corner portion) continuous with both the end portion 131a of the other side wall portion 131c and the end portion 131a of the other end wall portion 131d.

The coupling portion 133 couples the pair of side wall portions 131c and 131c to each other. For example, the coupling portion 133 includes coupling portions 133A and 133B provided to correspond to two second type holding areas 122, respectively. The coupling portion 133A couples the pair of side wall portions 131c and 131c to each other by coupling the first corner portion of the bottom portion 132A and the second corner portion of the bottom portion 132A to each other along the short side direction DS1. The coupling portion 133B couples the pair of side wall portions 131c and 131c to each other by coupling the third corner portion of the bottom portion 132B and the fourth corner portion of the bottom portion 132B to each other along the short side direction DS1.

In addition, the coupling portion 133 is provided along the board 101 to divide a region where the first type contact 11A is disposed and a region where the second type contact 11B is disposed. As illustrated in FIGS. 3A and 3B, an opening 134 is formed in the plug shell 13. The opening 134 is formed by, for example, cutting out a bottom surface portion, in a member having a square container-shape formed by drawing. For example, in the plug shell 13, two openings 134B each surrounding a region where two second type contact 11B is disposed are formed at both ends in the long side direction DL1. In addition, one opening 134A surrounding a region where six first type contacts 11A are disposed is formed in the plug shell 13. The coupling portion 133 is formed between the opening 134A and one opening 134B by a remaining portion of the cutout. In addition, the coupling portion 133 is formed between the opening 134A and the other opening 134B by a remaining portion of the cutout. Such a coupling portion 133 divides the region (opening 134A) where the first type contact 11A is disposed and the region (opening 134B) where the second type contact 11B is disposed.

As illustrated in FIGS. 3A to 3C, the coupling portion 133 has a partition wall portion 135 erected in a direction (connection direction CD1) away from the board 101. A length of the partition wall portion 135 in the short side direction DS1 is shorter than a length of a region other than the partition wall portion 135 of the coupling portion 133 in the short side direction DS1. As illustrated in FIGS. 2A to 2C, the partition wall portion 135 partitions the plug housing 12 into the first type holding area 121 that holds the first type contact 11A and the second type holding area 122 that holds the second type contact 11B. For example, the partition wall portion 135 includes a partition wall portion 135A and a partition wall portion 135B. The partition wall portion 135A is provided at a position (boundary PL1) that partitions one second type holding area 122 and the first type holding area 121 in the plug housing 12. The partition wall portion 135B is provided at a position (boundary PL2) that partitions the other second type holding area 122 and the first type holding area 121 in the plug housing 12.

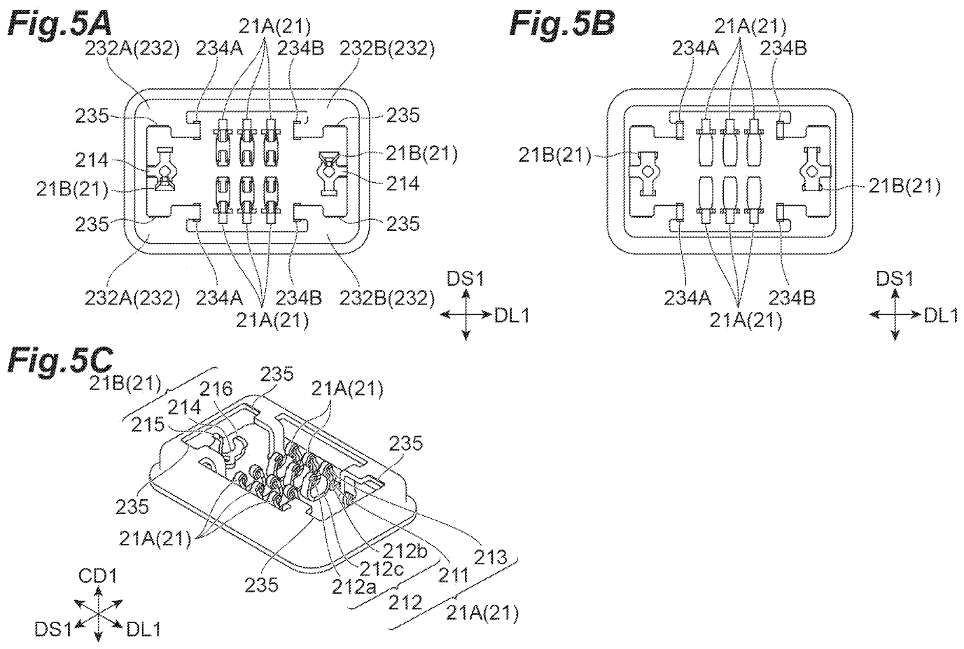

The engaging portions 136 protrude in the direction away from the board 101. The engaging portions 136 are connected to the ground conductor of the board 101. The engaging portions 136 engage with engaged portions 235 (see FIG. 5A) of the receptacle connector 20. For example, the engaging portion 136 is formed as a leaf spring having an S-shape extending along the connection direction CD1. The pair of engaging portions 136 is provided to sandwich the second type contact 11B in the short side direction DS1, for example. That is, a pair of contact points between the engaging portions 136 and the ground conductor of the board 101 is provided to sandwich the second type contact 11B.

In the plug shell 13 formed in this manner, each member is electrically connected. Note that, the ground conductor of the board 101 may be formed in a substantially circumferential shape to surround a plurality of conductors similarly formed on the board 101. Accordingly, after the plug connector 10 is attached, shielding performance of the entire board 101 may be further improved.

Note that, the above configuration is merely an example, and can be changed as appropriate. For example, the plug housing 12 may have at least one second type holding area 122, and may not necessarily have two or more second type holding areas 122. The plug housing 12 may be partitioned into four or more holding areas. The first type holding area 121 may not be necessarily interposed between two second type holding areas 122, and the second type holding areas 122 may be adjacent to each other.

### [Receptacle Connector]

Next, a configuration of the receptacle connector 20 will be described in detail. The receptacle connector 20 is attached to the board 201 and is connected to the plug connector 10 which is a mating connector. As illustrated in FIGS. 4A to 4C, the receptacle connector 20 includes the receptacle contact 21, a receptacle housing 22, and a receptacle shell 23.

The receptacle contact 21 is a conductive member electrically connected to a conductor (for example, signal conductor) of the board 201. In a state where the plug connector 10 and the receptacle connector 20 are fitted to each other, the receptacle contact 21 comes into contact with the plug contact 11 of the plug connector 10.

The receptacle contact 21 have contacts of different types. For example, the receptacle contact 21 includes one or a plurality of first type contacts 21A and one or a plurality of second type contacts 21B of a type different from the first type contact 21A. The second type contact 21B is a contact for transmitting a high frequency signal having a higher frequency than the signal transmitted by the first type contact 21A.

As an example, as illustrated in FIGS. 4A to 4C, the receptacle contact 21 includes six first type contacts 21A and two second type contacts 21B. In the long side direction DL1, for example, two second type contacts 21B are disposed at both ends, and six first type contacts 21A are disposed to be sandwiched between the two second type contacts 21B. In six first type contacts 21A, three sets of a pair of first type contacts 21A facing each other in the short side direction DS1 are disposed in the long side direction DL1. As viewed from the plug connector 10, six first type contacts 21A and two second type contacts 21B are disposed along the connection direction CD1.

The first type contact 21A has a pair of projection shapes to sandwich the first type contact 11A of the plug connector 10. The first type contacts 21A protrude toward the plug connector 10 along the connection direction CD1. The first type contact 21A is formed by punching one plate material from a metal plate and performing bending or the like on the plate material. The first type contact 21A is provided within the receptacle connector 20 along the short side direction DS1 to be connected to the conductor of the board 201.

The second type contact 21B protrudes toward the plug connector 10 along the connection direction CD1 to come into contact with the second type contact 11B of the plug connector 10. The second type contact 21B is formed by punching one plate material from a metal plate and performing bending or the like on the plate material. The second type contact 21B is provided near both ends within the receptacle connector 20 along the long side direction DL1 to be connected to the conductor of the board 201.

As illustrated in FIGS. 5A to 5C, the first type contact 21A includes a connection portion 211, a contact portion 212, and a coupling portion 213. The connection portion 211 is connected to the conductor (for example, signal conductor) of the board 201 by soldering or the like. The connection portion 211 extends outward along the short side direction DS1. The contact portion 212 comes into contact with the first type contact 11A of the plug connector 10. The contact portion 212 protrudes from a base end of an extension portion of the connection portion 211 toward the receptacle connector 20 along the connection direction CD1. The connection portion 211 and the contact portion 212 are coupled to each other by the coupling portion 213. The coupling portion 213 couples the connection portion 211 and a base portion (upper end) of the contact portion 212. The first type contact 21A may have any shape as long as the first type contact can be attached to the board 201, and for example, may have a shape in which the connection portion 211 does not extend outward.

More specifically, the contact portion 212 is a substantially U-shaped portion having a first portion 212a, a second portion 212b, and a coupling portion 212c. The first portion 212a and the second portion 212b protrude toward the plug connector 10 along the connection direction CD1, and sandwich the first type contact 11A of the plug connector 10 therebetween. The first portion 212a and the second portion 212b extend along the connection direction CD1 to face each other in the short side direction DS1. The coupling portion 212c couples a base portion (lower end) of the first portion 212a and a base portion (lower end) of the second portion 212b.

The second type contact 21B has a connection portion 214, a contact portion 215, and a projection portion 216. The connection portion 214 is connected to the conductor (for example, signal conductor) of the board 201 by soldering or the like. The connection portion 214 extends outward along the long side direction DL1 (see FIG. 5A). The contact portion 215 comes into contact with the second type contact 11B of the plug connector 10. The contact portion 215 protrudes from a base end of an extension portion of the connection portion 214 toward the plug connector 10 along the connection direction CD1. The projection portion 216 protrudes toward the plug connector 10 along the connection direction CD1 to be fixed to the receptacle housing 22. The contact portion 215 and the projection portion 216 are coupled to each other via the connection portion 214. Note that, in the present example, the second type contact 21B is different in shape from the first type contact 21A, but may have the same shape as the first type contact 21A.

The receptacle housing 22 illustrated in FIGS. 4A to 4C is an insulating member that holds the receptacle contact 21. The receptacle housing 22 is formed by, for example, injection molding of a resin material. As illustrated in FIG. 1, the receptacle housing 22 has a first portion R1 that approximates a rectangular as viewed from the plug connector 10, and second portions R2 provided at both ends of the first portion R1 in the long side direction DL1. The first portion R1 includes a pair of wall portions R11 extending along the long side direction DL1 and a recess portion R12 which is a groove provided along the short side direction DS1 at both ends of each of the pair of wall portions R11. The recess portion R12 is a space for housing the second wall portion P12 of the plug connector 10. In the first portion R1, the protrusion portion R13 extending along the long side direction DL1 between the pair of wall portions R11 is formed. As illustrated in FIGS. 4A to 4C, the receptacle contact 21 is disposed inward of an outer edge (edge portion having a maximum dimension in the long side direction DL1 and the short side direction DS1) of the receptacle housing 22 as viewed from the plug connector 10.

The receptacle housing 22 is partitioned into a plurality of holding areas in the direction perpendicular to the connection direction CD1. The plurality of holding areas include, for example, one first type holding area 221 and two second type holding areas 222. For example, the wall portion R11 and the protrusion portion R13 of the first portion R1 correspond to the first type holding area 221. In addition, the second portion R2 corresponds to the second type holding area 222. The first type holding area 221 and the second type holding area 222 are partitioned by, for example, boundaries RL1 and RL2 perpendicular to the long side direction DL1. In the receptacle housing 22, for example, both ends in the long side direction DL1 are partitioned as two second type holding areas 222, and a region sandwiched between the two second type holding areas 222 is partitioned as the first type holding area 221. That is, the receptacle housing 22 is partitioned into the second type holding area 222, the first type holding area 221, and the second type holding area 222 in this order along the long side direction DL1. Hereinafter, two second type holding areas 222 may be collectively referred to as the second type holding area 222.

The first type holding area 221 holds one or a plurality (for example, six) of first type contacts 21A. In the following description, a case where the first type holding area 221 holds six first type contacts 21A will be described. The second type holding area 222 holds one or a plurality of second type contacts 21B. In the following description, a case where each second type holding area 222 holds one second type contact 21B will be described.

The receptacle housing 22 has a front surface 22a facing the plug connector 10 in the connection direction CD1, a back surface 22b facing the board 201, and a side surface 22c formed from the front surface 22a to the back surface 22b. As illustrated in FIG. 4C, first type contact housing portions 22d, a second type contact housing portion 22e, a housing groove portion 22f, and a housing groove portion 22g are formed in the receptacle housing 22.

The first type contact housing portions 22d are a plurality of holes provided from the front surface 22a to the back surface 22b in the first type holding area 221. The first type contact housing portions 22d are formed at positions corresponding to the first type contacts 21A by the number of the first type contacts 21A (that is, 6), and house the first type contacts 21A. As viewed from the plug connector 10, the first type contacts 21A are housed to be exposed in the first type contact housing portions 22d. The first type contacts 21A are fixed to the first type contact housing portions 22d by press fitting or the like.

The second type contact housing portion 22e is a hole provided from the front surface 22a to the back surface 22b in each of the pair of second type holding areas 222. In addition, a recessed housing groove portion 22h (see FIG. 4B) provided on the back surface 22b is formed in the second type contact housing portion 22e. The housing groove portion 22h houses the projection portion 216 of the second type contact 21B. The second type contact housing portion 22e is formed at a position corresponding to the second type contact 21B and houses the second type contact 21B. As viewed from the plug connector 10, the second type contact 21B is housed to be exposed in the second type contact housing portion 22e. The second type contact housing portion 22e is fixed to the second type contact housing portion 22e by press fitting or the like.

The housing groove portion 22f is one or a plurality of grooves (recessed portions) provided on the front surface 22a in the first type holding area 221. The housing groove portion 22f houses the raised portion 12c of the plug housing 12.

The housing groove portion 22g is one or a plurality of grooves (recessed portions) provided in the front surface 22a in each of the pair of second type holding areas 222. The housing groove portion 22g houses the raised portion 12d of the plug housing 12.

The first type contact 21A held by the first type holding area 221 is adjacent to the second type contact 21B held by one second type holding areas 222 via the boundary RL1. In addition, the first type contact 21A held by the first type holding area 221 is adjacent to the second type contact 21B held by the other second type holding area 222 via the boundary PL2. An interval in the long side direction DL1 between the first type contact 21A and the second type contact 21B adjacent to each other via the boundaries RL1 and RL2 is larger than an interval between the first type contacts 21A adjacent to each other along the long side direction DL1 within the first type holding area 221.

The side surface 22c illustrated in FIG. 4B may be a straight line or a recessed shape. For example, in the receptacle housing 22, a recess portion 223 may be formed at a center of the side surface 22c in the long side direction DL1. The recess portion 223 in the long side direction DL1 may be formed from the front surface 22a to the back surface 22b. In the present example, as viewed from the plug connector 10, a portion (connection portion 211) extending in the short side direction DS1 to be connected to the board 201 from the first type contact 21A is exposed from the recess portion 223 in the long side direction DL1 of the receptacle housing 22. Accordingly, a connection state (implementation state) of the first type contact 21A with respect to the board 201 may be confirmed visually.

In addition, in the receptacle housing 22, a recess portion 224 may be formed at the center of the side surface 22c in the short side direction DS1. The recess portion 224 in the short side direction DS1 may be formed from the front surface 22a to the back surface 22b. In the present example, as viewed from the plug connector 10, a portion (connection portion 214) extending in the long side direction DL1 to be connected to the board 201 from the second type contact 21B is exposed from the recess portion 224 in the short side direction DS1 of the receptacle housing 22. Accordingly, a connection state (mounting state) of the second type contact 21B with respect to the board 201 may be confirmed visually.

In the receptacle housing 22, one or a plurality of locking holes 22k are formed along the boundaries RL1 and RL2. The locking hole 22k is a hole provided from the front surface 22a to the back surface 22b, and receives a locking portion 234 (see FIG. 4A) of the receptacle shell 23.

In the receptacle housing 22, a housing groove portion 22m is formed at a position corresponding to the engaging portion 136 of the plug connector 10 in the connection direction CD1 (see FIG. 4A). The housing groove portion 22m is one or a plurality of grooves (recessed portions) provided in the front surface 22a in each of the pair of second type holding areas 222. The housing groove portion 22m houses the engaging portion 136.

The receptacle shell 23 illustrated in FIGS. 4A to 4C is a conductive member electrically connected to the ground conductor of the board 201 by soldering or the like. The receptacle shell 23 surrounds a region having an outer shape that approximates a rectangle as viewed from the plug connector 10. The receptacle shell 23 is attached to the receptacle housing 22 to surround the receptacle housing 22. The receptacle shell 23 has a side portion 231, an upper portion 232, and a grounding connection portion 233. In the receptacle shell 23, the side portion 231 which is a side surface portion, the upper portion 232 which is an upper surface portion, and the grounding connection portion 233 which is a flange portion are integrally provided, in a member having a square container-shape formed by drawing a metal plate (for example, square tube drawing). Since the receptacle shell 23 is formed by drawing, a joint is not formed on the side portion 231.

The side portion 231 surrounds an outer periphery of the receptacle housing 22 to have a substantially quadrangular shape as viewed from the plug connector 10. The receptacle contact 21 is disposed within a region surrounded by the side portion 231. In addition, the side portion 231 has a pair of side wall portions 231c and 231c along the longitudinal direction (long side direction DL1) on the outer periphery of the receptacle housing 22, and a pair of end wall portions 231d and 231d continuous with the side wall portions 231c and along the direction (short side direction DS1) orthogonal to the longitudinal direction on the outer periphery of the receptacle housing 22 (see FIG. 4A).

The upper portion 232 continues with an end portion 231b of the side portion 231 in a direction away from the board 201 and extends within the region surrounded by the side portion 231. The upper portion 232 is provided to be continuous with both of two sides that constitute the side portion 231 and intersect with each other at four corners of the side portion 231 as viewed from the plug connector 10. As viewed from the receptacle connector 20, the upper portion 232 covers a part of the second type holding area 222.

As illustrated in FIG. 4A, the upper portion 232 includes an upper portion 232A and an upper portion 232B provided to correspond to two second type holding areas 122. The upper portion 232A has a portion (first corner portion) continuous with both the end portion 231b of one side wall portion 231c in the direction away from the board 201 and the end portion 231b of one end wall portion 231d, and a portion (second corner portion) continuous with both the end portion 231b of the other side wall portion 231c and the end portion 231b of one end wall portion 231d. In addition, the upper portion 232B has a portion (third corner portion) continuous with both the end portion 231b of one side wall portion 231c and the end portion 231b of the other end wall portion 231d, and a portion (fourth corner portion) continuous with both the end portion 231b of the other side wall portion 231c and the end portion 231b of the other end wall portion 231d.

The grounding connection portion 233 is provided to be continuous with the end portion 231a of the side portion 231 in the direction close to the board 201 and extends to an outside of the side portion 231. The grounding connection portion 233 is connected to the ground conductor (not illustrated) of the board 201 by soldering or the like. Accordingly, the receptacle shell 23 is sealed from the board 201 to the side portion 231. The grounding connection portion 233 may be directly connected to the ground conductor of the board 201 or may be connected to the ground conductor of the board 201 via another portion of the receptacle shell 23. In the following description, a case where the grounding connection portion 233 is directly connected to the ground conductor of the board 201 will be described.

The upper portion 232 has the locking portion 234 extending toward the board 201 along the connection direction CD1. The locking portion 234 is formed integrally with the upper portion 232 by, for example, bending a metal plate for forming the upper portion 232. The locking portion 234 is fixed to the locking hole 22k of the receptacle housing 22 (see FIG. 4B).

The locking portion 234 is electrically connected to the ground conductor (not illustrated) of the board 201. The locking portion 234 may be directly connected to the ground conductor of the board 201, or may be connected to the ground conductor of the board 201 via another portion of the receptacle shell 23. In the following description, a case where the locking portion 234A is directly connected to the ground conductor of the board 201.

The locking portion 234 partitions a region where the first type contact 21A is disposed and a region where the second type contact 21B is disposed. The locking portion 234 includes, for example, locking portions 234A continuous with the upper portion 232A and locking portions 234B continuous with the upper portion 232B. A pair of locking portions 234A is provided near both ends in the short side direction DS1 at a position (on the boundary RL1) partitioning one second type holding area 222 and the first type holding area 221 in the receptacle housing 22. A pair of locking portions 234B is provided near both ends in the short side direction DS1 at a position (on the boundary RL2) partitioning the other second type holding area 222 and the first type holding area 221 in the receptacle housing 22.

In a state where the plug connector 10 and the receptacle connector 20 are fitted to each other, the boundary PL1 and the boundary RL1 overlap, and the boundary PL2 and the boundary RL2 overlap. On the boundaries PL1 and RL1, the partition wall portion 135A is disposed between the pair of locking portions 234A provided in the short side direction DS1. On the boundaries PL2 and RL2, the partition wall portion 135B is disposed between the pair of locking portions 234B provided in the short side direction DS1. In other words, one locking portion 234A, the partition wall portion 135A, and the other locking portion 234A are sequentially disposed on the boundaries PL1 and RL1 along the short side direction DS1. In addition, on the boundaries PL2 and RL2, one locking portion 234B, the partition wall portion 135B, and the other locking portion 234B are disposed in this order along the short side direction DS1. That is, the locking portion 234 is disposed adjacent to the partition wall portion 135 along the short side direction DS1. In a state where the plug connector 10 and the receptacle connector 20 are fitted to each other, the partition wall portion 135 and the locking portion 234 partition into first type holding areas 121 and 221 for holding the first type contacts 11A and 21A, respectively, and second type holding areas 122 and 222 for holding the second type contacts 11B and 21B, respectively.

As illustrated in FIG. 5A, the upper portion 232 has the engaged portion 235. The engaged portion 235 is formed, for example, such that a part of the upper portion 232 is cut out along the short side direction DS1. The engaged portion 235 is engaged with the engaging portion 136 in a state where the plug connector 10 and the receptacle connector 20 are fitted to each other. For example, the engaging portion 136 is formed as a leaf spring having an S-shape extending along the connection direction CD1. Here, when the plug connector 10 and the receptacle connector 20 are fitted to each other, the engaged portion 235 comes into contact with an expanded portion having an S-shape of the engaging portion 136. In this state, a force is applied from the engaged portion 235 to the engaging portion 136 along the connection direction CD1, and thus, the engaging portion 136 is elastically deformed to escape from the engaged portion 235. In other words, the engaging portion 136 is inclined from the connection direction CD1. A force is further applied from the engaged portion 235 to the engaging portion 136 along the connection direction CD1, and thus, the engaging portion 136 receives the engaged portion 235 in a recessed portion having an S-shape. Then, since the force from the engaged portion 235 to the engaging portion 136 is weakened, a force restoring from the deformed state acts on the engaging portion 136. By doing this, the engaged portion 235 is engaged with the engaging portion 136.

In the receptacle shell 23 formed in this manner, the members are electrically connected. Note that, the ground conductor of the board 201 may be formed in a substantially circumferential shape to surround a plurality of conductors similarly formed on the board 201. Accordingly, after the receptacle connector 20 is attached, shielding performance of the entire board 201 may be further improved.

Note that, the above configuration is merely an example, and can be changed as appropriate. For example, the receptacle housing 22 may 22 may have at least one second type holding area 222, and may not necessarily have two or more second type holding areas 222. The receptacle housing 22 may be partitioned into four or more holding areas. The second type holding areas 222 may be adjacent to each other without the first type holding area 221 interposed between two second type holding areas 222.

### [Fitted State of Connector Device]

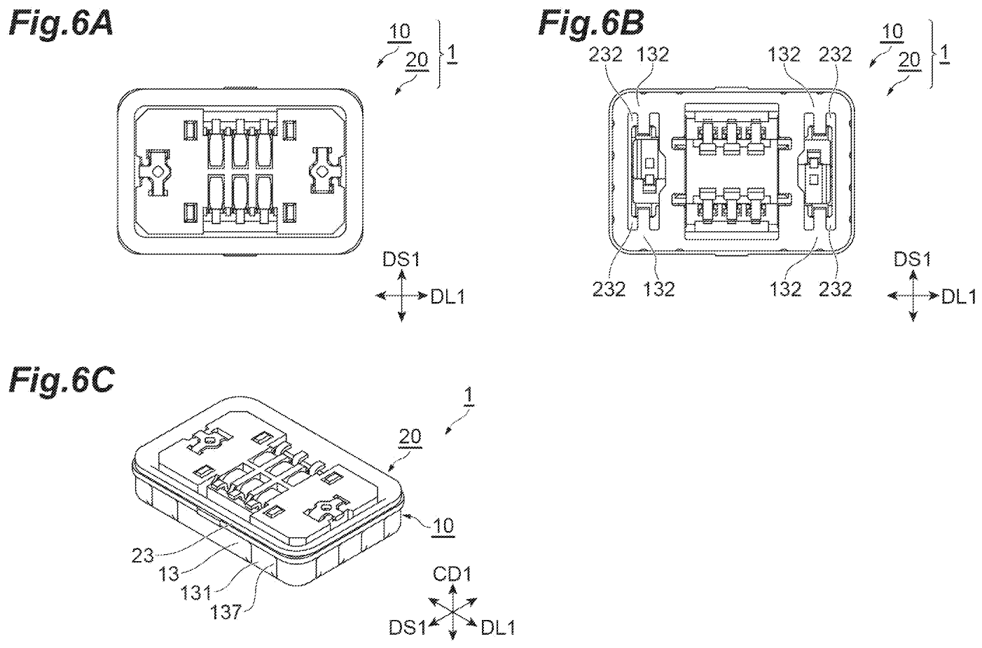

FIG. 6 is a diagram illustrating the connector device 1 in a state where the plug connector 10 and the receptacle connector 20 are fitted to each other. FIG. 6A is a plan view, FIG. 6B is a bottom view, and FIG. 6C is a perspective view.

As illustrated in FIGS. 6A and 6B, an outer edge of the plug connector 10 and an outer edge of the receptacle connector 20 approximate to each other. As illustrated in FIG. 6B, the bottom portion 132 and the upper portion 232 are disposed at positions overlapping each other at four corners of the connector device 1. In addition, as illustrated in FIG. 6C, the plug shell 13 is positioned on an outer periphery of the receptacle shell 23. The protrusion portion 137 presses the side portion 231 of the receptacle shell 23. That is, in a state where the plug connector 10 and the receptacle connector 20 are fitted to each other, the side portion 131 and the side portion 231 come into contact with each other via the protrusion portion 137. A contact portion between the side portion 131 and the side portion 231 may be adjusted by the protrusion portion 137. In addition, the fitted state of the connector device 1 may be strengthened by a pressing force of the protrusion portion 137.

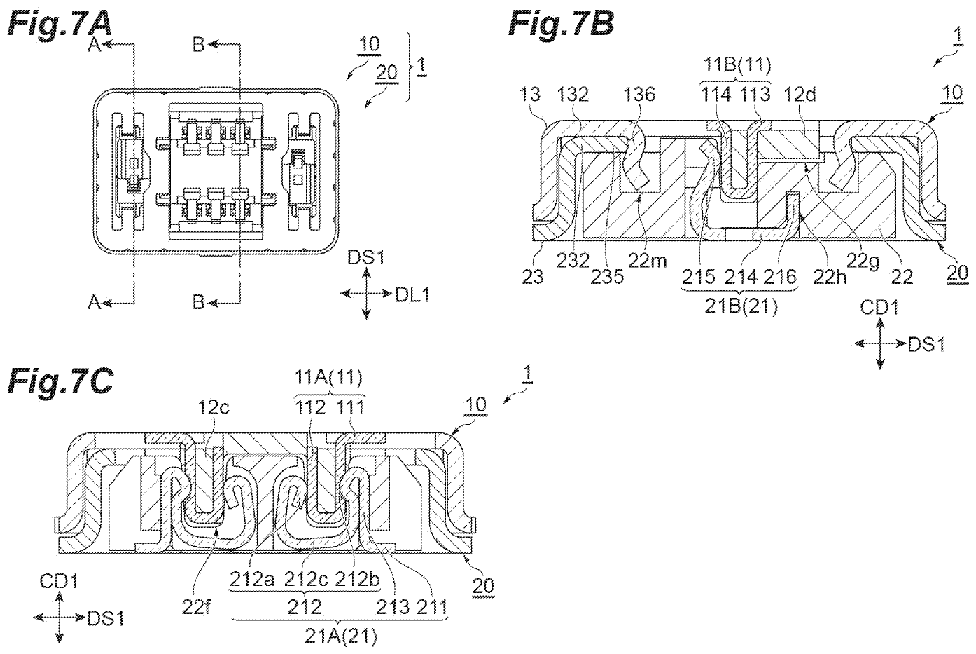

FIG. 7 is a diagram illustrating the connector device 1 in a state where the plug connector 10 and the receptacle connector 20 are fitted to each other. FIG. 7A is a bottom view, FIG. 7B is a sectional view illustrating a section taken along line A-A in FIG. 7A, and FIG. 7C is a sectional view illustrating a section taken along line B-B in FIG. 7A.

As illustrated in FIG. 7B, in a state where the plug connector 10 and the receptacle connector 20 are fitted to each other, the plug shell 13 is positioned on the outer periphery of the receptacle shell 23. The raised portion 12d of the plug connector 10 is housed in the housing groove portion 22g of the receptacle connector 20. The projection portion 216 of the second type contact 21B is fixed to the receptacle housing 22 by being housed in the housing groove portion 22h.

In addition, the engaging portion 136 of the plug connector 10 is housed in the housing groove portion 22m of the receptacle connector 20. In addition, the engaging portion 136 is engaged with the engaged portion 235 of the receptacle connector 20. In a state where the engaging portion 136 and the engaged portion 235 are engaged with each other, the bottom portion 132 of the plug connector 10 comes into contact with the upper portion 232 of the receptacle connector 20. For example, the upper portion 232 comes into contact to be pressed against the bottom portion 132 by an elastic force of the engaging portion 136. That is, the engaging portion 136 strengthens the fitted state between the plug connector 10 and the receptacle connector 20 and stabilizes contact between the upper portion 232 and the bottom portion 132.

In the connector device 1, the second type contact 11B and the second type contact 21B comes into contact with each other at one portion. More specifically, the contact portion 114 of the second type contact 11B protrudes toward the receptacle connector 20 along the connection direction CD1. In addition, the contact portion 114 is formed not to reach the connection portion 214 of the second type contact 21B. On the other hand, the contact portion 215 of the second type contact 21B protrudes toward the plug connector 10 along the connection direction CD1. In addition, the contact portion 215 is formed not to reach the connection portion 113 of the second type contact 21B. Then, in a state where the plug connector 10 and the receptacle connector 20 are fitted to each other, the contact portion 215 comes into contact with one side surface of the contact portion 114.

As illustrated in FIG. 7C, the raised portion 12c of the plug connector 10 is housed in the housing groove portion 22f of the receptacle connector 20.

In the connector device 1, the first type contact 21A comes into contact to sandwich the first type contact 11A. More specifically, the first portion 212a and the second portion 212b of the first type contact 21A protrude toward the plug connector 10 along the connection direction CD1. In addition, the first portion 212a and the second portion 212b are formed not to reach the connection portion 111 of the first type contact 11A. On the other hand, the contact portion 112 of the first type contact 11A protrudes toward the receptacle connector 20 along the connection direction CD1. In addition, the contact portion 112 is formed not to reach the coupling portion 212c of the first type contact 21A. Then, in a state where the plug connector 10 and the receptacle connector 20 are fitted to each other, the first portion 212a and the second portion 212b come into contact with each other at two portions to sandwich the contact portion 112 therebetween. The first portion 212a and the second portion 212b extend along the connection direction CD1 to face each other in the short side direction DS1.

### Effects of Present Example

The connector device 1 according to the aspect of the present example includes the plug connector 10 (first connector) and the receptacle connector 20 (second connector) fitted to the plug connector 10. The plug connector 10 includes the plug contact 11 (first contact) having the first type contact 11A and the second type contact 11B for transmitting a high frequency signal having a higher frequency than the signal transmitted by the first type contact 11A and electrically connected to the conductor of the board 101 (first board), the insulating plug housing 12 (first housing) that holds the plug contact 11, and the plug shell 13 (first shell) having the side portion 131 (first side portion) and a bottom portion. The first side portion surrounds the outer periphery of the plug housing 12. The bottom portion 132 is continuous with the end portion 131a of the side portion 131 in the direction close to the board 101. The bottom portion extends along the board 101 within the region surrounded by the side portion 131. The plug shell 13 is electrically connected to the ground conductor of the board 101. The receptacle connector 20 includes the receptacle contact 21 (second contact) electrically connected to the conductor of the board 201 (second board), the insulating receptacle housing 22 (second housing) that holds the receptacle contact 21, and the receptacle shell 23 (second shell) that has the side portion 231 (second side portion) and the upper portion 232. The side portion 231 surrounds the outer periphery of the receptacle housing 22. The upper portion 232 is continuous with the end portion 231b of the side portion 231 in the direction away from the board 201. The upper portion 232 extends within the region surrounded by the side portion 231. The receptacle shell 23 is electrically connected to the ground conductor of the board 201. In a state where the plug connector 10 and the receptacle connector 20 are fitted to each other, the plug contact 11 comes into contact with the receptacle contact 21, the side portion 131 comes into contact with the side portion 231, and the bottom portion 132 comes into contact with the upper portion 232.

In the connector device according to the aspect of the present disclosure, in a state where the plug connector 10 and the receptacle connector 20 are fitted to each other, the side portion 131 of the plug shell 13 and the side portion 231 of the receptacle shell 23 come into contact with each other, and the bottom portion 132 continuous with the side portion 131 and the upper portion 232 continuous with the side portion 231 come into contact with each other. The plug shell 13 and the receptacle shell 23 come into contact with each other at two points of the portion integrally configured in this manner, and thus, a ground potential difference between the plug shell 13 and the receptacle shell 23 is reduced. As a result, since shielding performance in the fitted state is stabilized, the shielding performance of the connector device 1 may be improved.

The connector assembly described in Japanese Unexamined Patent Publication No. 2017-208165 has two leg portions having the bent section. However, when a gap between two leg portions is large, the shielding performance may be deteriorated. On the other hand, in the connector device 1, since a double gap is not formed in the side portion 131 and the side portion 231, it is possible to suppress such deterioration in shielding performance.

In addition, in the connector assembly described in Japanese Unexamined Patent Publication No. 2017-208165, two leg portions are formed on the side surface of one connector, and thus, a difference in strength from the other connector occurs. For example, in one connector in which two leg portions are formed, strength against a torque load rotating about an axis along the fitting direction as a rotation axis decreases. On the other hand, in the connector device 1, each of the plug connector 10 and the receptacle connector 20 may be said to have a shape approximate to a substantially square container. That is, there is no difference in strength between the plug connector 10 and the receptacle connector 20. Accordingly, the connector device 1 becomes strong against a torque load that rotates about, for example, an axis along the connection direction CD1 as a rotation axis.

In the connector device 1, the side portion 131 surrounds the outer periphery of the plug housing 12 to have a substantially quadrangular shape as viewed from the receptacle connector 20. The side portion 131 includes the pair of side wall portions 131c and 131c (first side wall portions) and the pair of end wall portions 131d and 131d (first end wall portions). The pair of side wall portions 131c and 131c extend along the longitudinal direction on the outer periphery of the plug housing 12. The pair of end wall portions 131d and 131d are continuous with the pair of side wall portions 131c and 131c, and extend along the direction orthogonal to the longitudinal direction on the outer periphery of the plug housing 12. The plug contact 11 is disposed in a region surrounded by the side portion 131. According to such a configuration, the outer periphery of the plug housing 12 is surrounded by the side wall portions 131c and the end wall portions 131d of the side portion 131 without the joint, and the plug contact 11 is surrounded by the side portion 131. Accordingly, noise leakage through the side portion 131 is suppressed with respect to the outside of the connector device 1.

In the connector device 1, the side portion 231 surrounds the outer periphery of the receptacle housing 22 to have a substantially quadrangular shape as viewed from the plug connector 10. The side portion 231 includes the pair of side wall portions 231c and 231c (second side wall portions) and the pair of end wall portions 231d and 231d (second end wall portions). The pair of side wall portions 231c and 231c extend along the longitudinal direction on the outer periphery of the receptacle housing 22. The pair of end wall portions 231d and 231d are continuous with the pair of side wall portions 231c and 231c, and extend along the direction orthogonal to the longitudinal direction on the outer periphery of the receptacle housing 22. The receptacle contact 21 is disposed within a region surrounded by the side portion 231. According to such a configuration, the outer periphery of the receptacle housing 22 is surrounded by the side wall portions 231c and the end wall portions 231d of the side portion 231 without the joint, and the receptacle contact 21 is surrounded by the side portion 231. Accordingly, noise leakage through the side portion 231 is suppressed with respect to the outside of the connector device 1.

In the connector device 1, the bottom portion 132 includes the coupling portion 133 that couples the pair of side wall portions 131c to each other. According to such a configuration, a large area of the bottom portion 132 may be secured. As a result, noise leakage through the bottom portion 132 is suppressed with respect to the outside of the connector device 1.

In the connector device 1, the coupling portion 133 is provided along the board 101 to divide the region where the first type contact 11A is disposed and the region where the second type contact 11B is disposed. According to such a configuration, the region of the first type contact 11A and the second type contact 11B is divided along the board 101. Accordingly, an influence of mutual noise of the first type contact 11A and the second type contact 11B may be reduced.

In the connector device 1, the coupling portion 133 includes the partition wall portion 135. The partition wall portion 135 is erected in the direction away from the board 101. The partition wall portion 135 partitions the plug housing 12 into the first type holding area for holding the first type contact 11A and the second type holding area for holding the second type contact 11B. According to such a configuration, the second type contact 11B that easily becomes a noise source and is easily influenced by noise is isolated from the first type contact 11A. Accordingly, an influence of mutual noise of the first type contact 11A and the second type contact 11B may be reduced.

In the connector device 1, the bottom portion 132 has the engaging portion 136 protruding in the direction away from the board 101. The upper portion 232 has the engaged portion 235 to be engaged with the engaging portion 136 in the state where the plug connector 10 and the receptacle connector 20 are fitted to each other. The engaging portion 136 and the engaged portion 235 are engaged, and thus, disengagement of the fitted state is prevented. The bottom portion 132 and the upper portion 232 stably come into contact with each other. In addition, a contact portion between the plug shell 13 and the receptacle shell 23 is increased, and thus, the ground potential difference between the plug shell 13 and the receptacle shell 23 may be further reduced.

In the connector device 1, the pair of engaging portions 136 are provided to sandwich the second type contact 11B via the plug housing 12. According to such a configuration, the engaging portion 136 continuous with the bottom portion 132 is provided near the second type contact 11B. Ground connection is provided near the second type contact 11B, and thus, the high frequency signal output from the second type contact 11B hardly leaks to the outside of the connector device 1.

### Modified Example

It is to be understood that not all aspects, advantages and features described herein may necessarily be achieved by, or included in, any one particular example. Indeed, having described and illustrated various examples herein, it should be apparent that other examples may be modified in arrangement and detail.

In the above-described example, although it has been described that the plug connector 10 is the first connector and the receptacle connector is the second connector, the receptacle connector 20 may be the first connector, and the plug connector 10 may be the second connector.

In addition, in the above-described example, it has been described that the bottom portion 132 and the upper portion 232 come into contact with each other at four corners of the connector device 1, the contact portion is not limited thereto. The bottom portion 132 and the upper portion 232 may come into contact with each other on flat surfaces, or may come into contact with each other via a projection or the like formed on one of the flat surfaces. In addition, the side portion 231 may have a recess portion for receiving the protrusion portion 137. The protrusion portion 137 may not be formed on the side portion 131.

1. A connector device comprising: a first connector; and a second connector fitted to the first connector,
wherein the first connector comprises:
a first contact comprising a first type contact and a second type contact configured to transmit a high frequency signal of a higher frequency than a signal transmitted by the first type contact, wherein the first contact is electrically connected to a conductor of a first board,
an insulating first housing configured to hold the first contact, and
a first shell comprising a first side portion and a bottom portion, wherein the first side portion surrounds an outer periphery of the first housing, wherein the bottom portion is continuous with an end portion of the first side portion in a direction close to the first board, wherein the bottom portion extends along the first board within a region surrounded by the first side portion, and wherein the first shell is electrically connected to a ground conductor of the first board,
wherein the second connector comprises:
a second contact electrically connected to a conductor of a second board,
an insulating second housing configured to hold the second contact, and
a second shell comprising a second side portion and an upper portion, wherein the second side portion surrounds an outer periphery of the second housing, wherein the upper portion is continuous with an end portion of the second side portion in a direction away from the second board, wherein the upper portion extends within a region surrounded by the second side portion, and wherein the second shell is electrically connected to a ground conductor of the second board, and
wherein in a state where the first connector and the second connector are fitted to each other, the first contact comes into contact with the second contact, the first side portion comes into contact with the second side portion, and the bottom portion comes into contact with the upper portion.

2. The connector device according to claim 1,
wherein the first side portion surrounds the outer periphery of the first housing to have a substantially quadrangular shape in a plan view,
wherein the first side portion comprises a pair of first side wall portions and a pair of first end wall portions,
wherein the pair of first side wall portions extend along a longitudinal direction on the outer periphery of the first housing,
wherein the pair of first end wall portions are continuous with the pair of first side wall portions and extend along a direction orthogonal to the longitudinal direction on the outer periphery of the first housing, and
wherein the first contact is disposed within the region surrounded by the first side portion.

3. The connector device according to claim 1, wherein
wherein the second side portion surrounds the outer periphery of the second housing to have a substantially quadrangular shape in a plan view,
wherein the second side portion comprises a pair of second side wall portions and a pair of second end wall portions,
wherein the pair of second side wall portions extend along a longitudinal direction on the outer periphery of the second housing,
wherein the pair of second end wall portions are continuous with the pair of second side wall portions and extend along a direction orthogonal to the longitudinal direction on the outer periphery of the second housing, and
wherein the second contact is disposed within the region surrounded by the second side portion.

4. The connector device according to claim 2, wherein the bottom portion comprises a coupling portion configured to couple the pair of first side wall portions each other.

5. The connector device according to claim 4, wherein the coupling portion is provided along the first board to divide a region where the first type contact is disposed and a region where the second type contact is disposed.

6. The connector device according to claim 5,
wherein the coupling portion comprises a partition wall portion,
wherein the partition wall portion is erected in a direction away from the first board, and
wherein the partition wall portion is configured to partition the first housing into a first type holding area that holds the first type contact and a second type holding area that holds the second type contact.

7. The connector device according to claim 1,
wherein the bottom portion comprises an engaging portion configured to protrude in a direction away from the first board, and
wherein the upper portion comprises an engaged portion engaged with the engaging portion in the state where the first connector and the second connector are fitted to each other.

8. The connector device according to claim 7, wherein a pair of the engaging portions are provided to sandwich the second type contact.

9. The connector device according to claim 1,
wherein the second housing comprises a locking hole,
wherein the upper portion comprises a locking portion extending toward the second board, and
wherein the locking portion is fixed into the locking hole.

10. The connector device according to claim 9, wherein the locking portion is electrically connected to the ground conductor of the second board.

11. The connector device according to claim 1,
wherein the bottom portion is directly connected to the ground conductor of the first board.

12. The connector device according to claim 1,
wherein the first housing is formed integrally with the first contact by insert molding of a resin material.

13. The connector device according to claim 1,
wherein the second housing is formed by injection molding of a resin material.

14. The connector device according to claim 1,
wherein the first shell is formed by drawing a metal plate, so that the first side portion and the bottom portion are formed integrally without a joint between the first side portion and the bottom portion.

15. The connector device according to claim 14,
wherein the first shell is formed by square tube drawing.

16. The connector device according to claim 1,
wherein the second shell is formed by drawing a metal plate, so that the second side portion and the upper portion are formed integrally without a joint between the second side portion and the upper portion.

17. The connector device according to claim 16,
wherein the second shell is formed by square tube drawing.

18. The connector device according to claim 1,
wherein the first side portion comprises a protrusion portion protruding inward from an inner peripheral surface of the first side portion facing the first housing, and
wherein the protrusion portion presses the second side portion in the state where the first connector and the second connector are fitted to each other.
